(19) United States
(12) Patent Application Publication
(10) Pub. No.: US 2017/0115522 A1
(43) Pub. Date: Apr. 27, 2017

(54) LIQUID CRYSTAL DISPLAY HAVING INCREASED RESISTANCE TO SHORT CIRCUITS AND METHOD OF MANUFACTURING THE SAME

(71) Applicant: Samsung Display Co., Ltd, Yongin-si (KR)

(72) Inventors: Sung Jin MUN, Seongnam-si (KR); Hyun Jae YOO, Seoul (KR); Seung Kyu LEE, Cheonan-si (KR)

(21) Appl. No.: 15/262,949

(22) Filed: Sep. 12, 2016

(30) Foreign Application Priority Data
Oct. 26, 2015 (KR) 10-2015-0148639

(51) Int. Cl. G02F 1/1362; G02F 1/1368; G02F 1/1343; G02F 1/1335

(52) U.S. Cl. CPC G02F 1/13624; G02F 1/133512; G02F 1/136286; G02F 1/1368; G02F 1/13439; G02F 2201/121; G02F 2001/13629; G02F 2001/136218

(57) ABSTRACT

A liquid crystal display (LCD) comprising a first substrate, a second substrate facing the first substrate, a common electrode disposed on the second substrate and a black matrix disposed on the common electrode so as to be positioned between the common electrode and the first substrate.

This application claims priority to Korean Patent Application No. 10-2015-0148639 filed on Oct. 26, 2015 in the Korean Intellectual Property Office, the disclosure of which is incorporated herein by reference in its entirety.

### BACKGROUND OF THE INVENTION

1. Field of the Invention

Embodiments of the present invention relate generally to liquid crystal displays. More specifically, embodiments of the present invention relate to liquid crystal displays having increased resistance to short circuits and methods of their manufacture.

2. Description of the Related Art

With the development of multimedia, the importance of display devices is increasing. Accordingly, various types of display devices such as liquid crystal displays (LCDs) and organic light-emitting displays (OLEDs) are seeing increased use. In particular, LCDs have become one of the most widely used types of flat panel displays.

Generally, an LCD includes a pair of substrates having field generating electrodes, such as pixel electrodes and a common electrode, with a liquid crystal layer interposed between the two substrates. In an LCD, voltages are applied to field generating electrodes to generate an electric field in the liquid crystal layer. Accordingly, the alignment of liquid crystal molecules of the liquid crystal layer is determined, and polarization of incident light is controlled. As a result, a desired image is displayed on the LCD.

Vertically aligned (VA) mode LCDs, in which long axes of liquid crystal molecules are aligned perpendicular to upper and lower display panels when no electric field is applied, are one type of LCD that has been developed. In particular, super vertical alignment (SVA) mode LCDs generate vertical and horizontal electric fields using an electrode pattern having a micro-slit structure, and control the direction of liquid crystals using the vertical and horizontal electric fields, thereby increasing transmittance.

In such an SVA mode LCD, a short circuit can occur in an exposure process between an electrode disposed on a lower substrate and an electrode disposed on an upper substrate, causing liquid crystal molecules to pretilt abnormally. Accordingly, this can result in problems such as a texture defect, a stain defect, and an afterimage.

### SUMMARY OF THE INVENTION

Aspects of the present invention provide a liquid crystal display (LCD) structured to prevent a short circuit between an electrode disposed on a lower substrate and an electrode disposed on an upper substrate, as well as a method of manufacturing such an LCD.

Aspects of the present invention also provide an LCD structured to prevent an electric field drop between an upper substrate and a lower substrate, by preventing a short circuit between the upper substrate and the lower substrate. Aspects of the invention also provide a method of manufacturing such an LCD.

However, aspects of the present invention are not restricted to the ones set forth herein. The above and other aspects of the present invention will become more apparent to one of ordinary skill in the art to which the present invention pertains by referencing the detailed description of embodiments of the present invention given below.

An exemplary embodiment of the present invention discloses a liquid crystal display (LCD) comprising: a first substrate; a second substrate facing the first substrate; a common electrode disposed on the second substrate; and a black matrix disposed on the common electrode so as to be positioned between the common electrode and the first substrate.

An exemplary embodiment of the present invention also discloses an LCD comprising: a first substrate; a gate line disposed on the first substrate; a data line disposed on the first substrate and insulated from the gate line; a first switching device having a gate electrode connected to the gate line, and a first electrode connected to the data line; a shielding electrode disposed on the first switching device so as to overlap the gate electrode of the first switching device; a second substrate facing the first substrate; a common electrode disposed on the second substrate; and a black matrix disposed on the common electrode and at least partially overlapping the shielding electrode.

An exemplary embodiment of the present invention also discloses a method of manufacturing an LCD, the method comprising: forming a common electrode on a first substrate; forming a black matrix on the common electrode; and bonding the first substrate to a second substrate having a shielding electrode, wherein at least part of the shielding electrode overlaps the black matrix.

### BRIEF DESCRIPTION OF THE DRAWINGS

The above and other aspects and features of the present invention will become more apparent by describing in detail exemplary embodiments thereof with reference to the attached drawings, in which:

FIG. 1 is a schematic block diagram of a liquid crystal display (LCD) according to an embodiment of the present invention;

FIG. 2 is an equivalent circuit diagram of a pixel illustrated in FIG. 1;

FIG. 3 is a more detailed layout view of an embodiment of the pixel illustrated in FIG. 2;

FIG. 4 is a cross-sectional view taken along the line I-I′ of FIG. 3;

FIG. 5 is a cross-sectional view taken along the line II-IF of FIG. 3;

FIG. 6 is a cross-sectional view taken along the line of FIG. 3;

FIG. 7 is a more detailed layout view of another embodiment of the pixel illustrated in FIG. 2; and

FIG. 8 is a flowchart illustrating a method of manufacturing an LCD according to an embodiment of the present invention.

### DETAILED DESCRIPTION OF THE INVENTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. The various figures thus may not be to scale. Also, like reference numerals denote like elements.

All numerical values are approximate, and may vary. All examples of specific materials and compositions are to be taken as nonlimiting and exemplary only. Other suitable materials and compositions may be used instead.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments will be described with reference to the accompanying drawings.

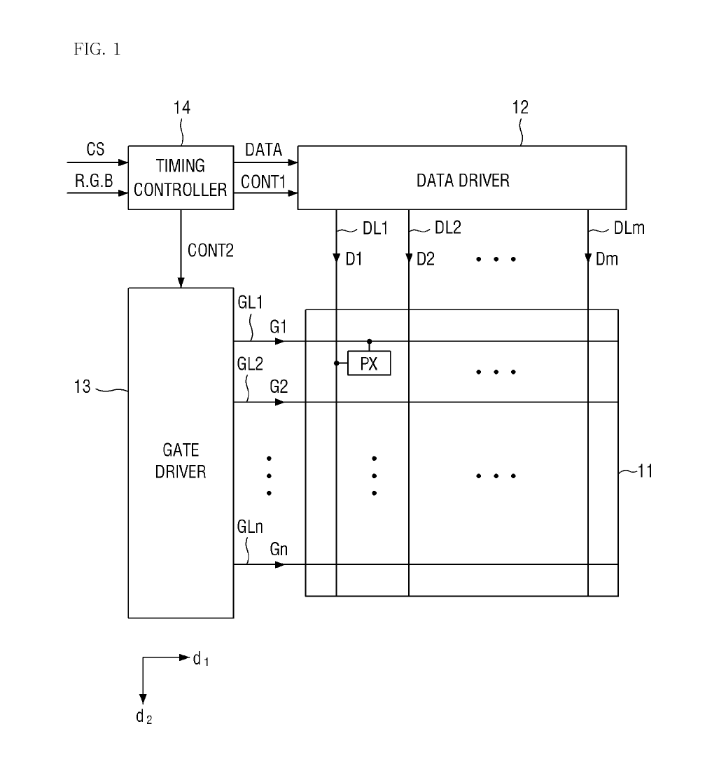

FIG. 1 is a schematic block diagram of a liquid crystal display (LCD) according to an embodiment of the present invention.

Referring to FIG. 1, an LCD according to the current embodiment may include a display panel 11, a data driver 12, a gate driver 13, and a timing controller 14.

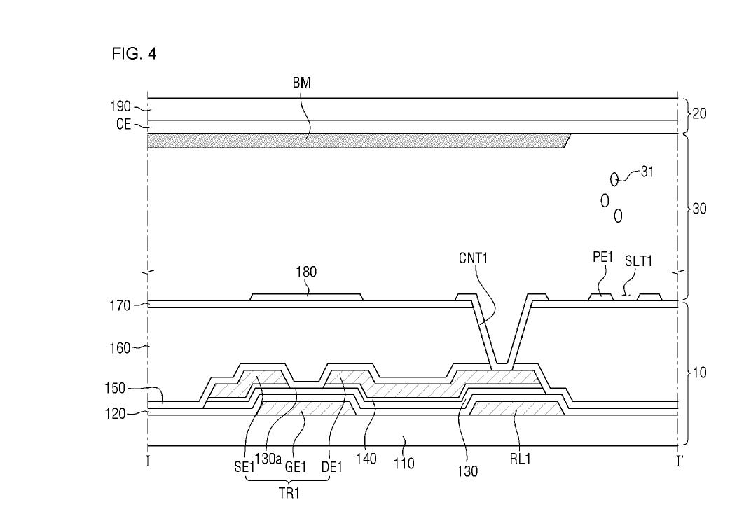

The display panel 11 is a panel that displays images. The display panel 11 may include a lower display panel 10 (see FIG. 4), an upper display panel 20 (see FIG. 4) which faces the lower display panel 10, and a liquid crystal layer 30 (see FIG. 4) which is interposed between the lower display panel 10 and the upper display panel 20. That is, the display panel 11 may be a liquid crystal panel.

The display panel 11 is connected to a plurality of gate lines GL1 through GLn (where n is a natural number of 1 or more) and a plurality of data lines DL1 through DLm (where m is a natural number of 1 or more). In addition, the display panel 11 includes a plurality of pixels, each connected to one of the gate lines GL1 through GLn and one of the data lines DL1 through DLm. The pixels may be arranged in a matrix according to an embodiment of the present invention. The gate lines GL1 through GLn may extend along a first direction d1. The data lines DL1 through DLm may extend along a second direction d2 different from the first direction d1. The first direction d1 and the second direction d2 may intersect each other. In FIG. 1, the first direction d1 is a row direction, and the second direction d2 is a column direction.

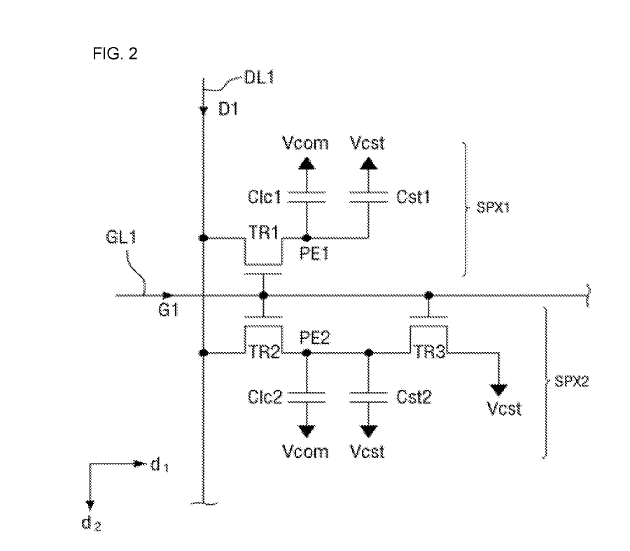

A pixel PX connected to the first gate line GL1 and the first data line DL1 will be described herein as a representative example of the pixels. The pixel PX may receive a first data signal D1 from the first data line DL1 in response to a first gate signal G1 received from the first gate line GL1. This will be described later with reference to FIG. 2.

The data driver 12 may include a shift register, a latch, and a digital-to-analog converter (DAC) according to an embodiment of the present invention. The data driver 12 may receive a first control signal CONT1 and image data DATA from the timing controller 14. The data driver 12 may select a reference voltage corresponding to the first control signal CONT1 and convert the received image data DATA from a digital waveform into a plurality of data signals D1 through Dm, based on the selected reference voltage. The data driver 12 may provide the generated data signals D1 through Dm to the display panel 11.

The gate driver 13 may receive a second control signal CONT2 from the timing controller 14. In response to the second control signal CONT2, the gate driver 13 may provide a plurality of gate signals G1 through Gn to the display panel 11.

The timing controller 14 may receive an image signal R, G, B and a control signal CS for controlling the image signal R, G, B, where both the image signal R, G, B and control signal CS are received from an external source. The control signal CS may include a vertical synchronization signal Vsync, a horizontal synchronization signal Hsync, a main clock signal MCLK, and a data enable signal DE according to an embodiment of the present invention. The timing controller 14 may generate the image data DATA, the first control signal CONT1 and the second control signal CONT2 by processing signals received from the external source according to the operating conditions of the display panel 11. The first control signal CONT1 may include a horizontal synchronization start signal STH for initiating input of the image data DATA, and a load signal TP for controlling the transmission of the data signals D1 through Dm to the data lines DL1 through DLm. The second control signal CONT2 may include a scan start signal STV for initiating output of the gate signals G1 through Gn, and a gate clock signal CPV for controlling the output timing of a scan-on pulse.

FIG. 2 is an equivalent circuit diagram of a pixel PX illustrated in FIG. 1.

Referring to FIG. 2, the pixel PX may include first and second subpixels SPX1 and SPX2.

The first subpixel SPX1 may include a first switching device TR1 and a first subpixel electrode PE1. The first switching device TR1 may be a three-terminal device such as a thin-film transistor (TFT) according to an embodiment of the present invention. The first switching device TR1 may have a gate electrode connected to the first gate line GL1, and a first electrode connected to the first data line DL1. In addition, the first switching device TR1 may have a second electrode connected to the first subpixel electrode PE1. The first electrode of the first switching device TR1 may be a source electrode according to an embodiment of the present invention, and the second electrode of the first switching device TR1 may be a drain electrode according to an embodiment of the present invention. The first switching device TR1 may be turned on by the first gate signal G1 received from the first gate line GL1, and may then transmit the first data signal D1 received from the first data line DL1 to the first subpixel electrode PE1.

The first subpixel SPX1 may further include a first liquid crystal capacitor Clc1 formed between the first subpixel electrode PE1 and a common electrode CE (see FIG. 4). The first liquid crystal capacitor Clc1 is charged by a difference between a voltage provided to the first subpixel electrode PE1 and a common voltage Vcom provided to the common electrode CE.

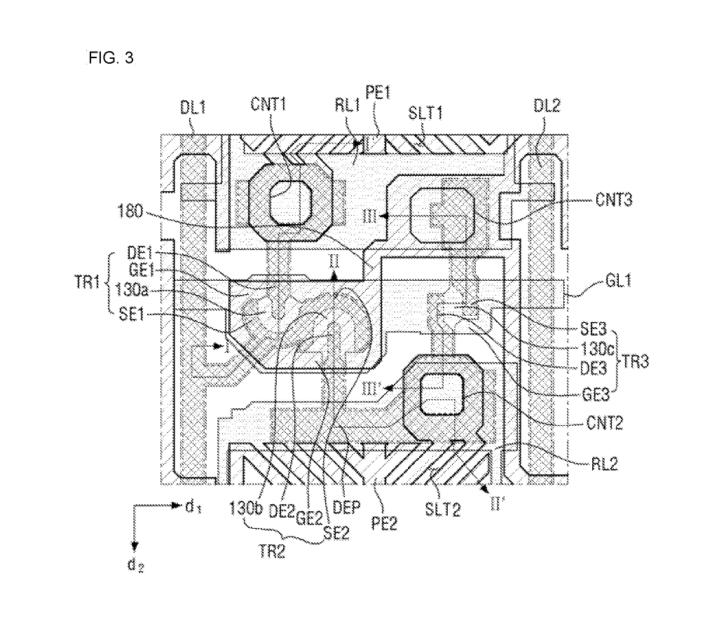

The first subpixel SPX1 may further include a first storage capacitor Cst1 formed between the first subpixel electrode PE1 and a first storage line RL1 (see FIG. 3). The first storage capacitor Cst1 is charged by a difference between the voltage provided to the first subpixel electrode PE1 and a storage voltage Vcst provided to the first storage line RL1.

The second subpixel SPX2 may include a second switching device TR2, a third switching device TR3, and a second subpixel electrode PE2. Each of the second and third switching devices TR2 and TR3 may be a three-terminal device such as a TFT according to an embodiment of the present invention.

The second switching device TR2 may have a gate electrode connected to the first gate line GL1, and a first electrode connected to the first data line DL1. In addition, the second switching device TR2 may have a second electrode connected to the second subpixel electrode PE2. The first electrode of the second switching device TR2 may be a source electrode according to an embodiment of the present invention, and the second electrode of the second switching device TR2 may be a drain electrode according to an embodiment of the present invention. That is, the second switching device TR2 may be turned on by the first gate signal G1 received from the first gate line GL1, and may thus transmit the first data signal D1 received from the first data line DL1 to the second subpixel electrode PE2.

The third switching device TR3 may have a gate electrode connected to the first gate line GL1, and a first electrode connected to the first storage line RL1. In addition, the third switching device TR3 may have a second electrode connected to the second subpixel electrode PE2. The first electrode of the third switching device TR3 may be a source electrode according to an embodiment of the present invention, and the second electrode of the third switching device TR3 may be a drain electrode according to an embodiment of the present invention. That is, the third switching device TR3 may be turned on by the first gate signal G1 received from the first gate line GL1, and may thus apply the storage voltage Vcst received from the first storage line RL1 to the second subpixel electrode PE2.

The second subpixel SPX2 may further include a second liquid crystal capacitor Clc2 formed between the second subpixel electrode PE2 and the common electrode CE. The second liquid crystal capacitor Clc2 may be charged by a difference between a voltage provided to the second subpixel electrode PE2 and the common voltage Vcom provided to the common electrode CE. However, as the third switching device TR3 is turned on, the voltage charged in the second liquid crystal capacitor Clc2 is divided. Accordingly, the level of voltage charged in the second liquid crystal capacitor Clc2 is lower than that of the voltage charged in the first liquid crystal capacitor Clc1.

That is, since the voltage charged in the first liquid crystal capacitor Clc1 of the pixel PX is different from the voltage charged in the second liquid crystal capacitor Clc2 of the pixel PX, liquid crystal molecules disposed between the first subpixel SPX1 and the common electrode CE may tilt at a different angle from an angle at which liquid crystal molecules disposed between the second subpixel SPX2 and the common electrode CE tilt. Therefore, the first subpixel SPX1 and the second subpixel SPX2 may have different luminance levels. By appropriately adjusting the voltages charged in the first and second liquid crystal capacitors Clc1 and Clc2 as described above, an image viewed from the side can be controlled to be close to an image viewed from the front, thereby improving lateral visibility.

The second subpixel SPX2 may further include a second storage capacitor Cst2 formed between the second subpixel electrode PE2 and a second storage line RL2 (see FIG. 3). The second storage capacitor Cst2 is charged by a difference between the voltage provided to the second subpixel electrode PE2 and the storage voltage Vcst provided to the second storage line RL2.

A case where the storage voltage Vcst is provided to both the first storage line RL1 and the second storage line RL2 is described herein. However, the present invention is not limited to this case. That is, the first and second storage lines RL1 and RL2 may be electrically insulated from each other and respectively receive signals having different voltage levels. Further, a case where the first electrode of the third switching device TR3 is connected to the first storage line RL1 is described herein. However, the present invention is not limited to this case. That is, the first electrode of the third switching device TR3 can also be connected to the second storage line RL2 or be connected to, and thus receive a signal from, an additional storage line separate from the first and second storage lines RL1 and RL2.

FIG. 3 is a more detailed layout view of an embodiment of the pixel PX illustrated in FIG. 2.

FIG. 4 is a cross-sectional view taken along the line I-I′ of FIG. 3.

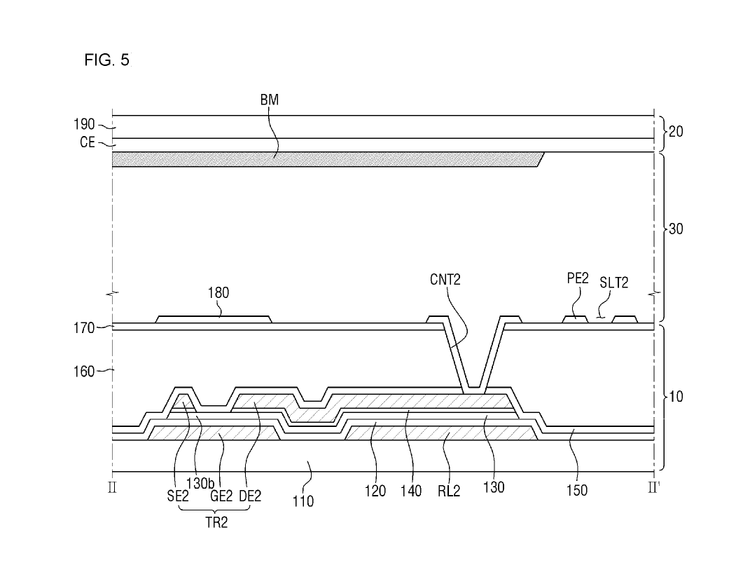

FIG. 5 is a cross-sectional view taken along the line II-IF of FIG. 3.

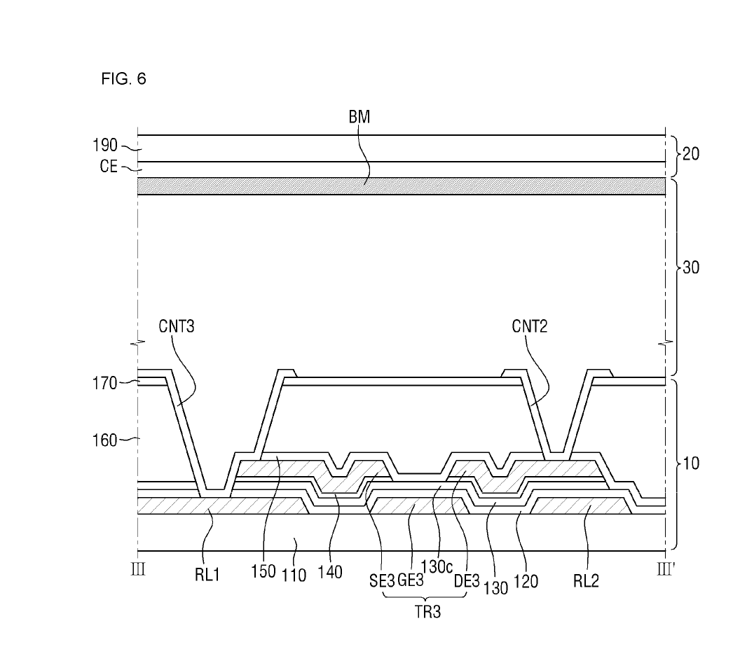

FIG. 6 is a cross-sectional view taken along the line of FIG. 3.

Referring to FIGS. 3 through 6, an LCD according to the current embodiment may include the lower display panel 10, the upper display panel 20, and the liquid crystal layer 30 interposed between the lower display panel 10 and the upper display panel 20. The lower display panel 10 is placed to face the upper display panel 20. The lower display panel 10 may be bonded with the upper display panel 20 by sealing.

For ease of description, the source and drain electrodes of the first switching device TR1 will hereinafter be referred to as first source and drain electrodes SE1 and DE1. In addition, the source and drain electrodes of the second switching device TR2 will hereinafter be referred to as second source and drain electrodes SE2 and DE2, and the source and drain electrodes of the third switching device TR3 will hereinafter be referred to as third source and drain electrodes SE3 and DE3.

First, the lower display panel 10 will be described below.

The first gate line GL1, first through third gate electrodes GE1 through GE3, the first storage line RL1, the second storage line RL2 and first through fourth storage electrodes RE1a through RE2b may be disposed on lower substrate 110.

The lower substrate 110 may be a transparent glass substrate or a plastic substrate according to an embodiment of the present invention.

The first gate line GL1 may extend generally along the first direction d1. The first through third gate electrodes GE1 through GE3 may be connected to the first gate line GL1. In FIG. 3, the first gate line GL1 may extend between the first and second subpixel electrodes PE1 and PE2.

Each of the first gate line GL1 and the first through third gate electrodes GE1 through GE3 may be a single layer, a double layer or a triple layer made of one conductive metal, at least two conductive metals or three conductive metals selected from aluminum (Al), copper (Cu), molybdenum (Mo), chrome (Cr), titanium (Ti), tungsten (W), molybdenum tungsten (MoW), molybdenum titanium (MoTi), and copper/molybdenum titanium (Cu/MoTi).

Referring to FIGS. 4 through 6, the first and second storage lines RL1 and RL2 may be disposed on the lower substrate 110. The first and second storage lines RL1 and RL2 may be disposed on the same layer as the first gate line GL1 and the first through third gate electrodes GE1 through GE3. The first and second storage lines RL1 and RL2 may be made of the same material as the first gate line GL1 and the first through third gate electrodes GE1 through GE3, according to an embodiment of the present invention. In addition, the first and second storage lines RL1 and RL2 may be formed at substantially the same time as the first gate line GL1 and the first through third gate electrodes GE1 through GE3, by employing a single mask process according to an embodiment of the present invention.

In FIG. 3, the first storage line RL1 may be disposed above the first gate line GL1. The first storage line RL1 may be shaped like a quadrilateral closed loop that surrounds the first subpixel electrode PE1. In FIG. 3, the second storage line RL2 may be disposed below the first gate line GL1. According to an embodiment of the present invention, the first and second storage lines RL1 and RL2 may surround the first and second subpixel electrodes PE1 and PE2, respectively. The first and second storage lines RL1 and RL2 may extend beyond a pixel area to be connected to another layer or to an external driver circuit. In addition, the first and second storage lines RL1 and RL2 may receive the same storage voltage Vcst (see FIG. 2), but the present invention is not limited thereto. That is, as described above, the first and second storage lines RL1 and RL2 may be insulated from each other and connected to different voltage sources, so as to receive voltages having different levels.

A gate insulating layer 120 may be disposed on the first gate line GL1, the first through third gate electrodes GE1 through GE3, the first storage line RL1 and the second storage line RL2. The gate insulating layer 120 may be made of silicon nitride (SiNx) or silicon oxide (SiOx) according to an embodiment of the present invention. The gate insulating layer 120 may also have a multilayer structure composed of at least two insulating layers with different physical characteristics.

A semiconductor layer 130 may be disposed on the gate insulating layer 120. The semiconductor layer 130 may include an oxide semiconductor. That is, the semiconductor layer 130 may be made of at least one oxide semiconductor selected from In—Ga-Zinc-Oxide (IGZO), ZnO, ZnO₂, CdO, SrO, SrO₂, CaO, CaO₂, MgO, MgO₂, InO, In₂O₂, GaO, Ga₂O, Ga₂O₃, SnO, SnO₂, GeO, GeO₂, PbO, Pb₂O₃, Pb₃O₄, TiO, TiO₂, Ti₂O₃, and Ti₃O₅. In another embodiment, the semiconductor layer 130 may be made of amorphous silicon or polycrystalline silicon. The semiconductor layer 130 may include first through third semiconductor patterns 130a through 130c. The first semiconductor pattern 130a may overlap the first gate electrode GE1, and the second semiconductor pattern 130b may overlap the second gate electrode GE2. Further, the third semiconductor pattern 130c may overlap the third gate electrode GE3.

An ohmic contact layer 140 may be disposed on the semiconductor layer 130. The ohmic contact layer 140 may be made of a material such as n+hydrogenated amorphous silicon heavily doped with an n-type impurity such as phosphorous, or may be made of silicide.

The first data line DL1, the second data line DL2, the first through third source electrodes SE1 through SE3, and the first through third drain electrodes DE1 through DE3 may be disposed on the gate insulating layer 120 and the ohmic contact layer 140. Each of the first data line DL1, the second data line DL2, the first through third source electrodes SE1 through SE3 and the first through third drain electrodes DE1 through DE3 may be a single layer, a double layer or a triple layer (or more) made of one conductive metal, at least two conductive metals, or three or more conductive metals, where these metals are selected from aluminum (Al), copper (Cu), molybdenum (Mo), chrome (Cr), titanium (Ti), tungsten (W), molybdenum tungsten (MoW), molybdenum titanium (MoTi), and copper/molybdenum titanium (Cu/MoTi). However, the present invention is not limited thereto, and each of the first data line DL1, the second data line DL2, the first through third source electrodes SE1 through SE3 and the first through third drain electrodes DE1 through DE3 can be made of various metals or conductors.

The first data line DL1, the second data line DL2, the first through third source electrodes SE1 through SE3, and the first through third drain electrodes DE1 through DE3 may be formed at the same time as the semiconductor layer 130 and the ohmic contact layer 140 by the same mask process, according to an embodiment of the present invention. In this case, the first data line DL1, the second data line DL2, the first through third source electrodes SE1 through SE3 and the first through third drain electrodes DE1 through DE3 may have substantially the same shape as the semiconductor layer 130, except for areas of the semiconductor layer 130 in which channels of the first through third switching devices TR1 through TR3 are located.

The first source electrode SE1, the first drain electrode DE1, the first gate electrode GE and the first semiconductor pattern 130a collectively form the first switching device TR1. The first source electrode SE1 of the first switching device TR1 may be connected to the first data line DL1. The first drain electrode DE1 of the first switching device TR1 may be electrically connected to the first subpixel electrode PE1 by a first contact hole CNT1. The second source electrode SE2, the second drain electrode DE2, the second gate electrode GE2 and the second semiconductor pattern 130b together form the second switching device TR2. The second source electrode SE2 of the second switching device TR2 may be connected to the first data line DL1. The second drain electrode DE2 of the second switching device TR2 may be electrically connected to the second subpixel electrode PE2 by a second contact hole CNT2. The second switching device TR2 may further include a drain electrode extension part DEP which extends from the second drain electrode DE2 to overlap the second storage line RL2. The drain electrode extension part DEP overlapping the second storage line RL2 can increase a capacitive component of the second storage capacitor Cst2. In addition, the drain electrode extension part DEP overlapping the second storage line RL2 can reduce a kickback voltage Vkb due to a parasitic component between the second gate electrode GE2 and the second drain electrode DE2 of the second switching device TR2.

The third source electrode SE3, the third drain electrode DE3, the third gate electrode GE3, and the third semiconductor pattern 130c collectively form the third switching device TR3. The third source electrode SE3 of the third switching device TR3 may be electrically connected to the first storage line RL1 so as to receive the storage voltage Vcst from the first storage line RL1.

The third drain electrode DE3 of the third switching device TR3 may be electrically connected to the second subpixel electrode PE2. Referring to FIG. 3, the third drain electrode DE3 of the third switching device TR3 may be integrally formed with the second drain electrode DE2 of the second switching device TR2. The third switching device TR3 provides the received storage voltage Vcst to the second subpixel electrode PE2, thereby dividing the voltage charged in the second liquid crystal capacitor Clc2.

A first passivation layer 150 may be disposed on the first data line DL1, the second data line DL2, the first through third source electrodes SE1 through SE3, the first through third drain electrodes DE1 through DE3 and the gate insulating layer 120. The first passivation layer 150 may be made of an inorganic insulating material such as silicon nitride or silicon oxide. The first passivation layer 150 may prevent a pigment of a color filter 160 from flowing into exposed portions of the semiconductor layer 130.

The color filter 160 may be formed on the first passivation layer 150. The color filter 160 may display one of three primary colors, i.e., red, green and blue, but the present invention is not limited thereto. The color filter 160 in each pixel may be made of a material of a different color from the color of a material that forms the color filter 160 in an adjacent pixel. As such, any pattern and arrangement of any colors is contemplated.

A second passivation layer 170 may be disposed on the color filter 160. The second passivation layer 170 may be made of an inorganic insulating material such as silicon nitride or silicon oxide. The second passivation layer 170 can prevent the lifting of an upper part of the color filter 160 and suppress the contamination of the liquid crystal layer 30 by organic matter (such as a solvent) introduced from the color filter 160, thereby preventing a defect such as an afterimage created during screen driving.

The first and second subpixel electrodes PE1 and PE2 may be disposed on the second passivation layer 170. The first subpixel electrode PE1 may be electrically connected to the first drain electrode DE1 of the first switching device TR1 via the first contact hole CNT1. The second subpixel electrode PE2 may be electrically connected to the second drain electrode DE2 of the second switching device TR2 via the second contact hole CNT2. Each of the first and second subpixel electrodes PE1 and PE2 may be made of a transparent conductive material such as indium tin oxide (ITO) or indium zinc oxide (IZO) or a reflective metal such as aluminum, silver, chrome or an alloy thereof.

The first subpixel electrode PE1 may include a plurality of first slits SLT1 according to an embodiment of the present invention. The second subpixel electrode PE2 may include a plurality of second slits SLT2 according to an embodiment of the present invention. In the first subpixel electrode PE1, for example, the first slits SLT1 form a fringe field between the first subpixel electrode PE1 and the common electrode CE which will be described later, thus causing some liquid crystal molecules 31 to rotate in a certain direction. The overall shape of each of the first and second subpixel electrodes PE1 and PE2 may be a quadrilateral shape according to an embodiment of the present invention. Each of the first and second subpixel electrodes PE1 and PE2 may include a cross-shaped stem part having a plurality of horizontal stem parts and a plurality of vertical stem parts intersecting the horizontal stem parts.

A shielding electrode 180 may be disposed on the second passivation layer 170. The shielding electrode 180 may be disposed on the same layer as the first and second subpixel electrodes PE1 and PE2. The shielding electrode 180 may be made of a transparent conductive material such as ITO or IZO, or a reflective metal such as aluminum, silver, chrome or an alloy thereof according to an embodiment of the present invention. The shielding electrode 180 may overlap the first gate electrode GE1 of the first switching device TR1. In addition, the shielding electrode 180 may overlap the second gate electrode GE2 of the second switching device TR2. Further, the shielding electrode 180 may overlap a black matrix BM which will be described later.

The shielding electrode 180 may overlap the first and second data lines DL1 and DL2 according to an embodiment of the present invention. Accordingly, the shielding electrode 180 can prevent leakage of light due to the coupling between the first and second data lines DL1 and DL2 and their adjacent first and second subpixel electrodes PE1 and PE2.

The shielding electrode 180 may be electrically connected to the first storage line RL1 by a third contact hole CNT3, according to an embodiment of the present invention. That is, the shielding electrode 180 may receive the storage voltage Vcst through the first storage line RL1.

Alternatively, the shielding electrode 180 may not be electrically connected to the first storage line RL1 according to another embodiment of the present invention. In this case, the shielding electrode 180 may be electrically connected to the common electrode CE and may thus receive the common voltage Vcom from the common electrode CE. Therefore, since the same voltage is applied to the shielding electrode 180 and the common electrode CE, no electric field is formed between the shielding electrode 180 and the common electrode CE. Accordingly, a plurality of liquid crystal molecules 31 located between the shielding electrode 180 and the common electrode CE may not be induced to be aligned in a certain direction. As a result, black may be displayed between the shielding electrode 180 and the common electrode CE.

Although not illustrated in the drawings, a first alignment layer may be disposed on the first subpixel electrode PE1, the second subpixel electrode PE2 and the shielding electrode 180. The first alignment layer may be made of, e.g., polyimide.

Next, the upper display panel 20 will be described.

An upper substrate 190 may be placed to face the lower substrate 110. The upper substrate 190 may be made of, e.g., transparent glass or plastic. In an embodiment of the present invention, the upper substrate 190 may be made of the same material as the lower substrate 110.

The common electrode CE may be disposed on the upper substrate 190. For example, the common electrode CE may directly contact the upper substrate 190. At least part of the common electrode CE may overlap the first and second subpixel electrodes PE1 and PE2 and the shielding electrode 180. The common electrode CE may form an electric field with each of the first and second subpixel electrodes PE1 and PE2. The liquid crystal molecules 31 may be aligned according to the generated electric field. However, since the level of the voltage charging the second liquid crystal capacitor Clc2 is lower than that of the voltage charging the first liquid crystal capacitor Clc1 as described above, liquid crystal molecules located between the second subpixel electrode PE2 and the common electrode CE may be aligned different from liquid crystal molecules located between the first subpixel electrode PE1 and the common electrode CE.

The black matrix BM may be disposed on the common electrode CE. The black matrix BM disposed on the common electrode CE can block light from transmitting through an area other than the pixel area.

In particular, the black matrix BM may be disposed between the shielding electrode 180 and the common electrode CE. Accordingly, the shielding electrode 180 and the common electrode CE can be prevented from short-circuiting in an exposure process.

More specifically, in a conventional LCD, the black matrix BM is placed on the upper substrate 190, and then the common electrode CE is placed on the black matrix BM. Accordingly, a short circuit can occur in the exposure process between the common electrode CE and the shielding electrode 180 or between the common electrode CE and the first and second subpixel electrodes PE1 and PE2. The short circuit can trigger an electric field drop between the upper substrate 190 and the lower substrate 110, thus causing a plurality of liquid crystal molecules to pretilt abnormally. This abnormal pretilt can cause a texture defect, a stain defect, an afterimage defect, etc. of the display panel 11.

On the other hand, in an LCD according to the current embodiment, the common electrode CE is formed on the upper substrate 190 before the black matrix BM. This structure can prevent a short circuit between the common electrode CE and each of the first subpixel electrode PE1, the second subpixel electrode PE2 and the shielding electrode 180.

That is, a minimum distance from the shielding electrode 180 or a surface of the lower substrate 110 to the common electrode CE may be greater than a minimum distance from the shielding electrode 180 or the surface of the lower substrate 110 to the black matrix BM.

An LCD according to the current embodiment may omit an overcoat layer. Accordingly, the process of forming the upper display panel 20 can be simplified. Further, although not illustrated in the drawings, a height of a column spacer disposed between the lower display panel 10 and the upper display panel 20 may be reduced. In this case, a cell gap between the lower display panel 10 and the upper display panel 20 can be maintained even without the formation of the overcoat layer.

Although not illustrated in the drawings, a second alignment layer (not illustrated) may be formed on the common electrode CE and the black matrix BM. The second alignment layer may be made of, e.g., polyimide.

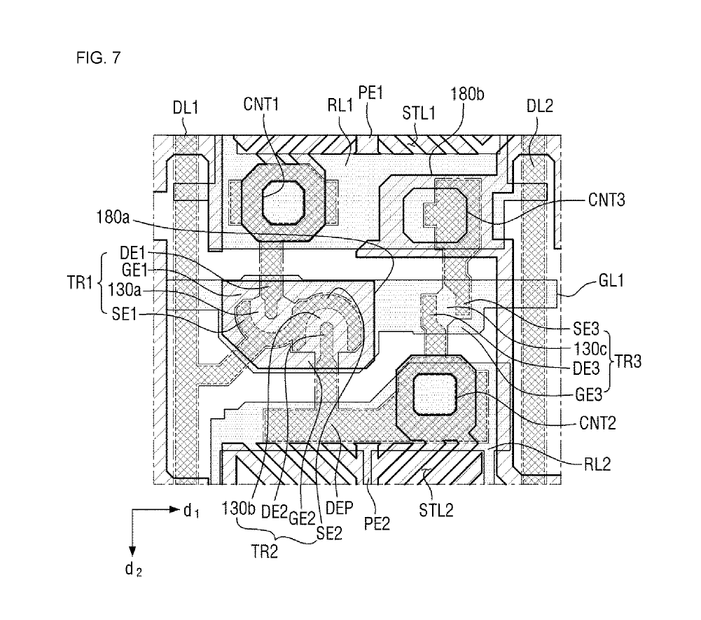

FIG. 7 is a more detailed layout view of another embodiment of the pixel PX illustrated in FIG. 2. For simplicity, any redundant description of elements identical to those described above with reference to FIGS. 3 through 6 will be omitted.

Referring to FIG. 7, an LCD according to the current embodiment may include a first shielding electrode 180a and a second shielding electrode 180b.

The first shielding electrode 180a may be disposed on the same layer as the second shielding electrode 180b but may be electrically insulated from the second shielding electrode 180b. That is, the first shielding electrode 180a may be in a floating state.

The second shielding electrode 180b may overlap first and second data lines DL1 and DL2. The second shielding electrode 180b may be electrically connected to a first storage line RL1 by a third contact hole CNT3, according to an embodiment of the present invention. That is, the second shielding electrode 180b may receive a storage voltage Vcst through the first storage line RL1.

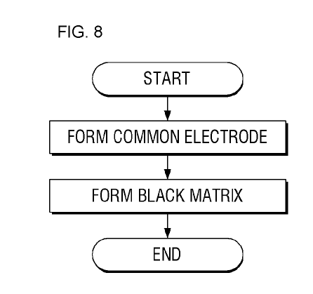

FIG. 8 is a flowchart illustrating a method of manufacturing an LCD according to an embodiment of the present invention.

The method of manufacturing an LCD according to the current embodiment includes manufacturing a lower display panel 10, manufacturing an upper display panel 20, and bonding the lower display panel 10 and the upper display panel 20 together. Here, the manufacturing of the lower display panel 10 and the manufacturing of the upper display panel 20 can be performed in any order.

The manufacturing of the upper display panel 20 will now be described with reference to FIGS. 3 through 6 and 8.

First, an upper substrate 190 is prepared.

Then, a common electrode CE is formed on the upper substrate 190. That is, the common electrode CE may directly contact the upper substrate 190. The common electrode CE may include a transparent conductive material such as ITO or IZO.

Next, a black matrix BM is formed on the common electrode CE. The black matrix BM may be placed to overlap at least part of each of a first gate electrode GE1 of a first switching device TR1 and a second gate electrode GE2 of a second switching device TR2. In addition, the black matrix BM may be placed to overlap a shielding electrode 180. That is, the black matrix BM may be placed so as to be positioned between the shielding electrode 180 and the common electrode CE.

Although not illustrated in the drawings, an alignment layer may be formed on the black matrix BM and the common electrode CE.

Meanwhile, the lower display panel 10 having first through third switching devices TR1 through TR3, a first gate line GL1, first and second data lines DL1 and DL2, etc. is prepared. Next, the lower display panel 10 and the upper display panel 20 are bonded together using a sealant, according to an embodiment of the present invention.

According to embodiments of the present invention, a short circuit between an electrode disposed on a lower substrate and an electrode disposed on an upper substrate can be prevented. Accordingly, an electric field drop between the upper and lower substrates can be prevented.

In addition, it is possible to prevent liquid crystal molecules from pretilting abnormally.

Furthermore, a texture defect, a stain defect and an afterimage can be improved. However, the effects of the present invention are not restricted to the one set forth herein. The above and other effects of the present invention will become more apparent to one of daily skill in the art to which the present invention pertains by referencing the claims. Various features of the above described and other embodiments can be mixed and matched in any manner, to produce further embodiments consistent with the invention.

What is claimed is:

1. A liquid crystal display (LCD) comprising:
a first substrate;
a second substrate facing the first substrate;
a common electrode disposed on the second substrate; and
a black matrix disposed on the common electrode so as to be positioned between the common electrode and the first substrate.

2. The LCD of claim 1, wherein a minimum distance from a surface of the first substrate to the common electrode is greater than a minimum distance from the surface of the first substrate to the black matrix.

3. The LCD of claim 1, wherein the common electrode directly contacts the second substrate.

4. The LCD of claim 1, further comprising:
a gate line disposed on the first substrate;
a data line disposed on the first substrate and insulated from the gate line;
a first switching device having a gate electrode connected to the gate line and a first electrode connected to the data line;
a first subpixel electrode connected to a second electrode of the first switching device; and
a shielding electrode disposed on the same layer as the first subpixel electrode, wherein at least part of the shielding electrode overlaps the gate electrode of the first switching device.

5. The LCD of claim 4, wherein the shielding electrode comprises at least one of indium tin oxide (ITO) and indium zinc oxide (IZO).

6. The LCD of claim 4, wherein the shielding electrode is in a floating state.

7. The LCD of claim 4, wherein the shielding electrode overlaps the black matrix.

8. The LCD of claim 4, further comprising:
a second switching device having a gate electrode connected to the gate line and a first electrode connected to the data line;
a second subpixel electrode connected to a second electrode of the second switching device; and
a third switching device having a gate electrode connected to the gate line, a first electrode connected to a storage line, and a second electrode connected to the second subpixel electrode.

9. The LCD of claim 8, wherein each of the first and second subpixel electrodes comprises a plurality of slits.

10. A liquid crystal display (LCD) comprising:
a first substrate;
a gate line disposed on the first substrate;
a data line disposed on the first substrate and insulated from the gate line;
a first switching device having a gate electrode connected to the gate line, and a first electrode connected to the data line;
a shielding electrode disposed on the first switching device so as to overlap the gate electrode of the first switching device;
a second substrate facing the first substrate;
a common electrode disposed on the second substrate; and
a black matrix disposed on the common electrode, the black matrix at least partially overlapping the shielding electrode.

11. The LCD of claim 10, wherein the black matrix is disposed between the shielding electrode and the common electrode.

12. The LCD of claim 10, wherein a minimum distance from the shielding electrode to the black matrix is smaller than a minimum distance from the shielding electrode to the common electrode.

13. The LCD of claim 10, wherein the shielding electrode comprises at least one of indium tin oxide (ITO) and indium zinc oxide (IZO).

14. The LCD of claim 10, further comprising a first subpixel electrode connected to a second electrode of the first switching device, wherein the first subpixel electrode is disposed on the same layer as the shielding electrode.

15. The LCD of claim 14, further comprising:
a second switching device having a gate electrode connected to the gate line, and a first electrode connected to the data line;
a second subpixel electrode connected to a second electrode of the second switching device; and
a third switching device having a gate electrode connected to the gate line, a first electrode connected to a storage line, and a second electrode connected to the second subpixel electrode.

16. The LCD of claim 15, wherein the gate electrode of the second switching device overlaps the shielding electrode.

17. A method of manufacturing a liquid crystal display (LCD), the method comprising:
forming a common electrode on a first substrate;
forming a black matrix on the common electrode; and
bonding the first substrate to a second substrate having a shielding electrode,
wherein at least part of the shielding electrode overlaps the black matrix.

18. The method of claim 17, wherein the first and second substrates are bonded so that the black matrix is placed between the shielding electrode and the common electrode.

19. The method of claim 17, wherein a minimum distance from the shielding electrode to the black matrix is smaller than a minimum distance from the shielding electrode to the common electrode.

20. The method of claim 17, wherein the shielding electrode comprises at least one of indium tin oxide (ITO) and indium zinc oxide (IZO).
